(19) United States
(12) Patent Application Publication
(10) Pub. No.: US 2017/0008372 A1
(43) Pub. Date: Jan. 12, 2017

(54) AIR-BLOWING DEVICE

(71) Applicant: DENSO CORPORATION, Kariya-city, Aichi-pref. (JP)

(72) Inventors: Shinya KATO, Kariya-city (JP); Yasuhiro SEKITO, Kariya-city (JP); Syunsuke ISHIGURO, Kariya-city (JP)

(73) Assignee: Denso Corporation, Aichi (JP)

(21) Appl. No.: 15/123,703

(22) PCT Filed: Mar. 23, 2015
(86) PCT No.: PCT/JP2015/001615

§ 371 Date: Sep. 6, 2016

(30) Foreign Application Priority Data
Mar. 27, 2014 (JP) 2014-065943

(51) Int. Cl. B60H 1/00; B60S 1/02; B60H 1/34

(52) U.S. Cl. CPC B60H 1/00871; B60H 1/00678; B60H 1/00064; B60H 1/3421; B60S 1/023; B60H 2001/00721; B60H 2001/00214

(57) ABSTRACT

An air-blowing device has a wall portion, a duct, and a guide wall. The wall portion is provided with a blowing outlet having an opening periphery extending in one direction. The duct has a first wall and a second wall facing the first wall and therein provides an air passage communicating with the blowing outlet. The guide wall curves from the first wall to be away from the second wall and is connected with an edge providing the opening periphery. The guide wall guides air flowing in the air passage to blow from the blowing outlet in a direction from the second wall toward the first wall. The edge extends to have a shape protruding in a direction from the first wall toward the second wall.

### CROSS REFERENCE TO RELATED APPLICATION

This application is based on Japanese Patent Application No. 2014-065943 filed on Mar. 27, 2014, the disclosure of which is incorporated herein by reference.

### TECHNICAL FIELD

The present disclosure relates to an air-blowing device that blows air.

### BACKGROUND ART

Patent Literature 1 discloses an air-blowing device in which a defroster blowing outlet that blows air toward a windshield of a vehicle and a blowing outlet that blows air toward a passenger are commonalized. The air-blowing device has a duct, a guide wall, a nozzle, and a controlled air blowing outlet. The duct communicates with the blowing outlet. The guide wall is provided in a blowing outlet portion of the duct at least on a side adjacent to an inside of a vehicle compartment. The nozzle is provided inside of the duct. The controlled air blowing outlet blows controlled air toward an upstream side of the nozzle in a flow direction of air. The guide wall has a curved shape. The nozzle generates a high-speed airflow by reducing a main flow. The controlled air blowing outlet is provided on both of a vehicle front side and a vehicle rear side and configured such that the controlled air is blown only one of the two controlled air blowing outlet.

According to the air-blowing device, a switching of a blowing direction of air blowing from the blowing outlet is performed by the controlled air. That is, the high-speed airflow from the nozzle approaches the vehicle front side by blowing the controlled air from the vehicle rear side toward the vehicle front side. Accordingly, air blows from the blowing outlet toward the windshield. On the other hand, the high-speed airflow from the nozzle approaches the vehicle rear side by blowing the controlled air from the vehicle front side toward the vehicle rear side. Accordingly, the high-speed airflow is bent by the Coanda effect while flowing along the guide wall, and air blows from the blowing outlet toward a passenger.

### PRIOR ART LITERATURES

### Patent Literature

Patent Literature 1: JP H01-027397 Y2

### SUMMARY OF INVENTION

According to studies by the inventors of the present disclosure, air is blown in parallel from the blowing outlet toward a rear side when the air blows from the blowing outlet toward the passenger in a case where the blowing outlet extends straight in a lateral direction of the vehicle in the air-blowing device. As a result, only air from a portion of the blowing outlet facing the passenger in front of the passenger reaches to the passenger, and air from the rest portion of the blowing outlet may flow a lateral side of the passenger.

Such an abnormality may be caused in not only the air-blowing device of Patent Literature 1, but also in another air-blowing device in which air that is bent by the Coanda effect to flow along a guide wall blows from a blowing outlet toward a target.

The present disclosure addresses the above issues, and it is an objective of the present disclosure to provide an air-blowing device that can blow air concentrically to a target when the air blows from a blowing outlet to the target.

An air-blowing device according to a first aspect of the present disclosure has a wall portion, a duct, and a guide wall. The wall portion is provided with a blowing outlet having an opening periphery extending in one direction. The duct has a first wall and a second wall facing the first wall and therein provides an air passage communicating with the blowing outlet. The guide wall curves from the first wall to be away from the second wall and is connected with an edge providing the opening periphery. The guide wall guides air flowing in the air passage to blow from the blowing outlet in a direction from the second wall toward the first wall. The edge extends to have a shape protruding in a direction from the first wall toward the second wall.

Here, the air blowing from the duct through the blowing outlet flows along the guide wall. Accordingly, a blowing direction of the air blowing out of the blowing outlet is set by a shape of the edge that is connected to the guide wall in the opening periphery of the blowing outlet. That is, the blowing direction of the air is a perpendicular direction that is perpendicular to the edge of the opening periphery connected to the guide wall. The perpendicular direction of the edge is a direction perpendicular to the edge when the edge has a straight shape, and the perpendicular direction of the edge is a direction perpendicular to a tangential line tangent to the edge when the edge has a curved shape. Therefore, in a case that the edge connected to the guide wall extends straight, the blowing direction of air is a direction perpendicular to the edge extending straight, and the air blows from the blowing outlet in parallel.

According to the present disclosure, air from the blowing outlet can be converged and concentrated to the target as compared to a case that the blowing outlet extends straight since the edge that is provided with the opening periphery of the blowing outlet and connected to the guide wall extends to have the shape protruding in the direction from the first wall toward the second wall.

### BRIEF DESCRIPTION OF DRAWINGS

FIG. 1 is a schematic view illustrating an air-blowing device and an air conditioning unit on a condition of being mounted in a vehicle, according to a first embodiment.

FIG. 2 is a perspective cross sectional view illustrating a part of the air-blowing device shown in FIG. 1.

FIG. 3 is a planar view illustrating an inside of a vehicle compartment to show an arrangement of a blowing outlet shown in FIG. 1.

FIG. 4 is an enlarged view illustrating the blowing outlet located on a driver seat side.

FIG. 5 is a schematic view illustrating a configuration of the air conditioning unit shown in FIG. 1.

FIG. 6 is an enlarged view illustrating the blowing outlet and a duct shown in FIG. 1 in a face mode.

FIG. 7 is an enlarged view illustrating the blowing outlet and the duct shown in FIG. 1 in a defroster mode.

FIG. 8 is an enlarged view illustrating the blowing outlet and the duct shown in FIG. 1 in the defroster mode.

FIG. 9 is a planar view illustrating a blowing outlet located on a driver seat side in an air-blowing outlet according to a first comparable example.

FIG. 10 is a schematic diagram illustrating an air arrival site in a windshield in the defroster mode of the air-blowing outlet according to the first embodiment.

FIG. 11 is a schematic diagram illustrating an air arrival site in a windshield in a defroster mode of the air-blowing outlet according to the first comparable example.

FIG. 12 is a cross sectional view illustrating an air-blowing device according to a second embodiment and taken along a line XII-XII shown in FIG. 13.

FIG. 13 is a cross sectional view taken along a line XIII-XIII shown in FIG. 12.

FIG. 14 is a cross sectional view illustrating an airflow deflector according to the second embodiment.

FIG. 15 is a cross sectional view illustrating an air-blowing device according to a third embodiment.

FIG. 16 is a cross sectional view taken along a line XVI-XVI shown in FIG. 15.

FIG. 17 is a planar view illustrating an locational relationship between a blowing outlet shown in FIG. 15 and a seat and a wind velocity distribution of air from the blowing outlet.

FIG. 18 is a cross sectional view illustrating a duct in an air-blowing device according to a second comparable example.

FIG. 19 is a planar view illustrating an locational relationship between a blowing outlet and a seat and a wind velocity distribution of air from the blowing outlet according to the second comparable example.

FIG. 20 is a planar view illustrating the blowing outlet of the air-blowing device according to the third embodiment.

FIG. 21 is a cross sectional view taken along a line XXI-XXI shown in FIG. 20.

FIG. 22 is a cross sectional view taken along a line XXII-XXII shown in FIG. 20.

FIG. 23 is a planar view illustrating a blowing outlet of an air-blowing device according to a third comparable example.

FIG. 24 is a planar view illustrating a blowing outlet of an air-blowing device according to another modification.

FIG. 25 is a planar view illustrating a blowing outlet of an air-blowing device according to another modification.

### DESCRIPTION OF EMBODIMENTS

Embodiments of the present disclosure will be described hereafter referring to drawings. In the embodiments, a part that corresponds to or equivalents to a matter described in a preceding embodiment may be assigned with the same reference number. An upper, lower, front, rear, left and right indicated by each arrow in drawings are a direction on a condition of being mounted in a vehicle.

### First Embodiment

According to the present embodiment, an air-blowing device of the present disclosure is used for a blowing outlet and a duct of an air conditioning unit that is mounted in a front area in a vehicle.

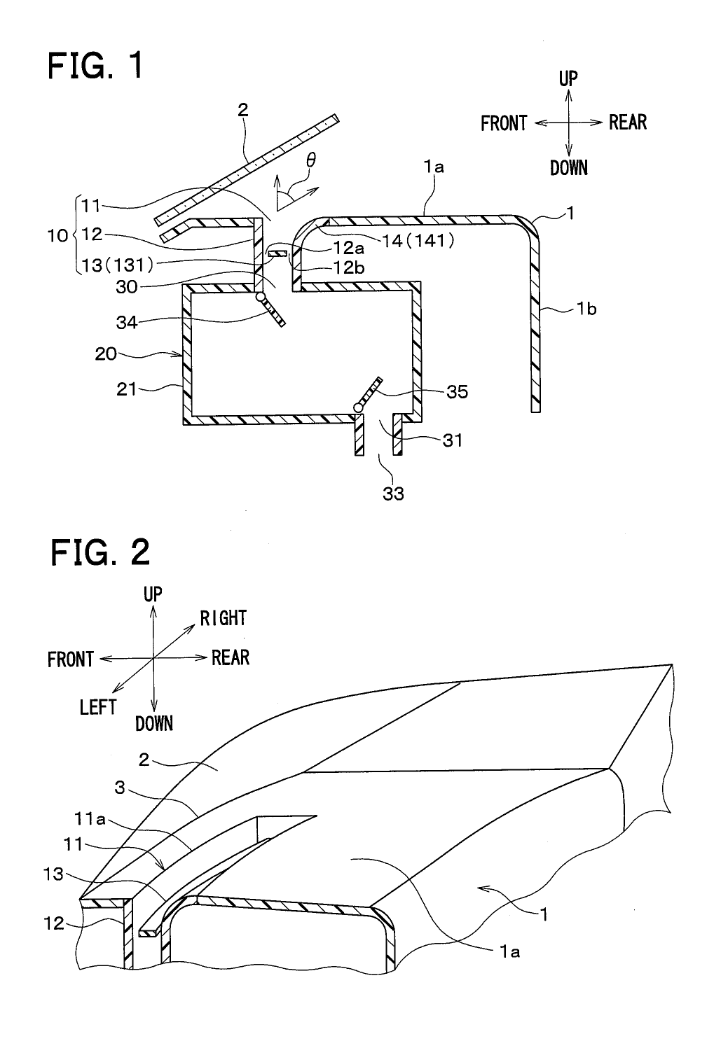

As shown in FIG. 1 and FIG. 2, an air-blowing device 10 has a blowing outlet 11, a duct 12, and an airflow deflection door 13. The blowing outlet 11 is located in an upper surface 1a of an instrument panel (i.e., a dash board) 1 on a side adjacent to a windshield 2. The duct 12 connects the blowing outlet 11 and an air conditioning unit 20 with each other. The airflow deflection door 13 is located inside the duct 12.

The instrument panel 1 is the dash board provided in the front area of a vehicle compartment and has the upper surface 1a and a design surface 1b. The instrument panel 1 is an entirety of a panel located in front of a front seat in the vehicle compartment and includes not only a portion in which instruments are arranged, but also a portion in which an audio device and an air conditioner.

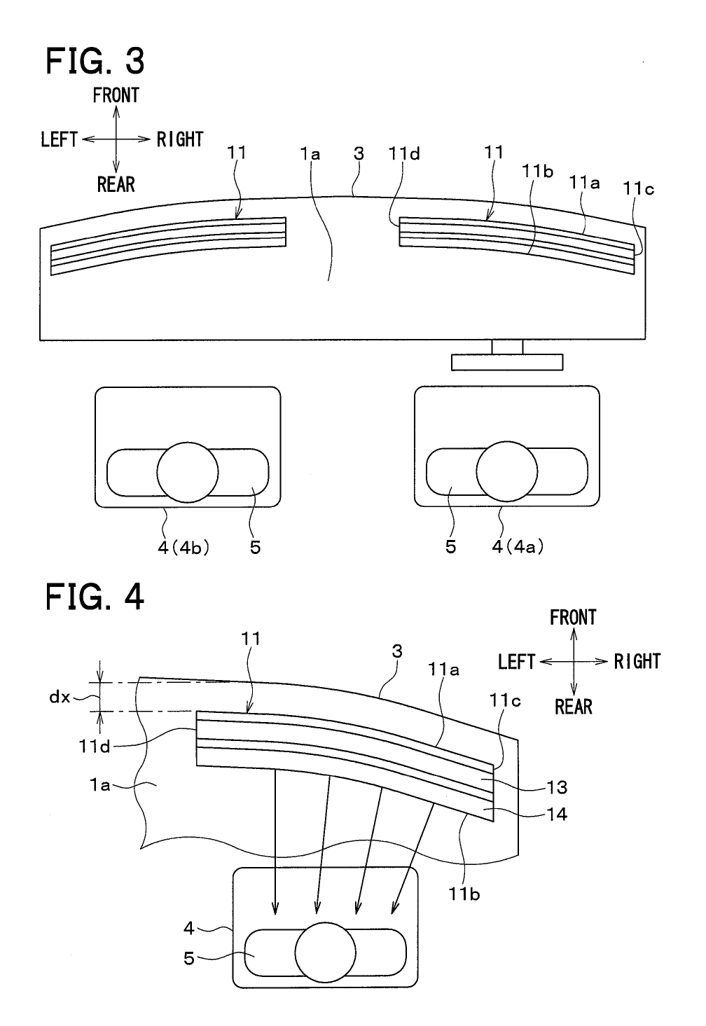

As shown in FIG. 3, two blowing outlets 11 are respectively arranged in two sites that are located in front of a driver seat 4a and a passenger seat 4b in the vehicle with a steering wheel on a right side. Although the blowing outlet 11 located in front of the driver seat 4a will be described hereinafter, the blowing outlet 11 located in front of the passenger seat 4b has a similar configuration as the blowing outlet 11 located in front of the driver seat 4a. The blowing outlet 11 extends slenderly in a vehicle width direction (i.e., a lateral direction of the vehicle), and a length of the blowing outlet 11 in the vehicle width direction is longer than a length of the seat 4 in the vehicle width direction.

As shown in FIG. 3 and FIG. 4, the upper surface 1a has a boundary 3 between the upper surface 1a and the windshield 2. The boundary 3 is an edge of the upper surface 1a being in contact with the windshield 2. The boundary 3 curves to protrude toward a front side of the vehicle, in other words, in a direction away from the seat 4. The blowing outlet 11 has a shape fitting to the boundary 3 and located in the upper surface 1a to have a specified dimension dx away from the boundary 3. Accordingly, the blowing outlet 11, in the upper surface 1a, curves to protrude frontward, in other words, in a direction away from the seat 4.

As shown in FIG. 4, the blowing outlet 11 is configured by opening peripheries 11a, 11b, 11c, 11 d provided with the upper surface 1a of the instrument panel 1. According to the present embodiment, the upper surface 1a configures a wall portion that is provided with the blowing outlet 11 having the opening peripheries 11a-11d and extending in one direction (i.e., the lateral direction).

The opening peripheries 11a-11d has a pair of long edges 11a, 11b and a pair of short edges 11c, 11d in a surface of the upper surface 1a. The pair of long edges 11a, 11b is located on a front side and a rear side and extends in the lateral direction. The pair of short edges 11c, 11d connects end portions of the pair of long edges 11a, 11 b respectively. According to the present embodiment, a rearward corresponds to “a direction from a second wall toward a first wall” of duct 12 that will be described after, and a frontward corresponds to “a direction from the first wall toward the second wall” of the duct 12 that will be described after. The lateral direction corresponds to “one direction” that will be described after.

According to the present embodiment, the pair of long edges 11a, 11b has a curved shape parallel with the boundary 3. Therefore, the long edge (i.e., the edge) 11b, which is a rear edge of the opening periphery, curves to protrude rearward, in other words, frontward from the seat 4 on which a passenger 5 seats. The dimension dx between the boundary 3 and the long edge 11a that is a front edge of the opening periphery is uniform.

The airflow deflection door 13 sets one of three outlet modes of a defroster mode, an upper vent mode and a face mode, and the blowing outlet 11 blows air of which temperature is adjusted. In the defroster mode, air is blown toward the windshield 2 and defogs the windshield 2. In the face mode, air is blown toward an upper body of the passenger 5 having a front seat. In the upper vent mode, air is blown more upward as compared to the face mode and toward a passenger having a rear seat.

As shown in FIG. 1, the blowing outlet 11 is configured by an opening formed in an end of the duct 12. In other words, the duct 12 is connected to the blowing outlet 11. The duct 12 therein provides an air passage in which air blowing from the air conditioning unit 20 flows. The duct 12 is made of resin and configured separately from the air conditioning unit 20. The duct 12 is connected to the air conditioning unit 20. An end of the duct 12 on an upstream side in a flow direction of air is connected to a defroster/face opening 30 of the air conditioning unit 20. The duct 12 may be formed integrally with the air conditioning unit 20.

The airflow deflection door 13 is an airflow deflector that deflects an airflow from the blowing outlet 11. Deflecting an airflow means changing a flow direction of the airflow. The airflow deflection door 13 changes a ratio between a sectional area of a front path 12a located on a front side of the airflow deflection door 13 inside the duct 12 and a sectional area of a rear path 12b located on a rear side of the airflow deflection door 13 inside the duct 12. The front path (i.e., a second path) 12a is provided between the airflow deflection door (i.e., the airflow deflector) 13 and the second wall (i.e., a front wall) of the duct 12, and the rear path (i.e., a first path) 12b is provided between the airflow deflection door 13 and the first wall (i.e., a rear wall) of the duct 12. Accordingly, a wind velocity in the front path 12a and a wind velocity in the rear path 12b are different from each other. As a result, a direction of the airflow from the blowing outlet 11 is varied.

According to the present embodiment, a slide door 131 that is slidable in a front-rear direction is used as the airflow deflection door 13. The slide door 131 has a length in the front-rear direction of the vehicle which is shorter than a width of the duct 12 in the front-rear direction and with which the front path 12a and the rear path 12b can be provided. By sliding the slide door 131 in the front-rear direction, the slide door 131 (i) generates a high-speed airflow (i.e., a jet flow) in the rear path 12b and (ii) can switch between a first state in which a low-speed airflow is generated in the front path 12a and a second state in which an airflow that is different from the low-speed airflow generated in the first state is generated inside the duct 12. As shown in FIG. 4, the slide door 131 extends parallel with the long edge 11b providing the opening periphery of the blowing outlet 11 such that a dimension between the slide door 131 and a guide wall 14 becomes uniform.

The slide door 131 curves to protrude frontward.

The duct 12 has the first wall (i.e., the rear wall) and the second wall (i.e., the front wall) facing the first wall. The rear wall has the guide wall 14 in a portion of the blowing outlet 11. The guide wall 14 is connected to the upper surface 1a of the instrument panel 1. The guide wall 14 controls a flow direction of the high-speed airflow inside the duct 12 to flow rearward along a wall surface of the guide wall 14 by Coanda effect, such that air flows rearward from the blowing outlet 11. In other words, the guide wall 14 guides air flowing in the air passage to blow from the blowing outlet 11 in a direction from the second wall toward the first wall (i.e., rearward). A passage width of the duct 12 in the portion of the blowing outlet 11, in other words, a distance between the rear wall and the front wall is expanded toward a downstream side in the flow direction of air by the guide wall 14. According to the present embodiment, the guide wall 14 curves such that the wall surface protrudes toward an inside of the duct 12. In other words, the guide wall 14 curves from an upper end of the first wall to be away from the second wall and is connected to the long edge (i.e., the edge) 11a providing the opening periphery.

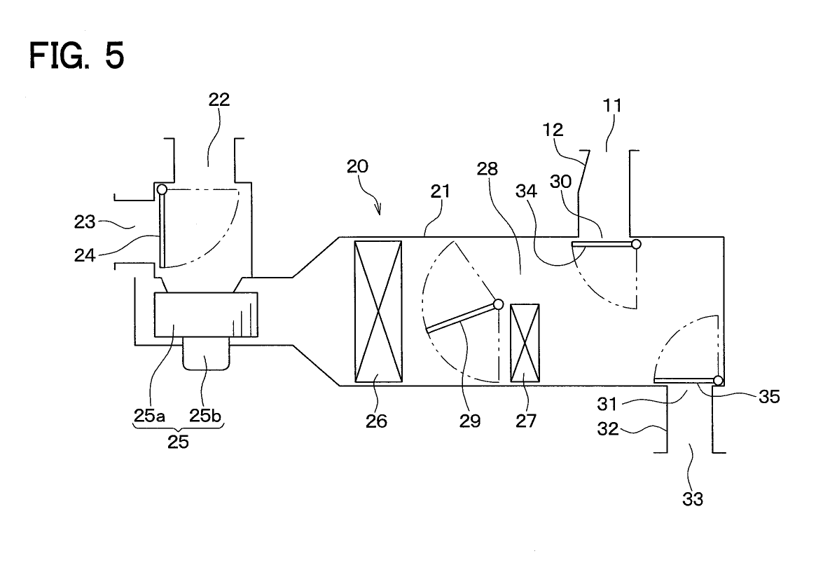

The air conditioning unit 20 is arranged inside the instrument panel 1. As shown in FIG. 5, the air conditioning unit 20 has an air conditioning case 21 configuring an outer shall. The air conditioning case 21 configures an air passage that guides air into the vehicle compartment that is a target space for air conditioning. In a most upstream portion of the air conditioning case 21 in the flow direction of air, an inside air suction port 22 that draws air inside the vehicle compartment (i.e., an inside air) and an outside air suction port 23 that draws air outside the vehicle compartment (i.e., an outside air) are provided. Further, a suction port opening/closing door 24 that opens or closes the inside air suction port 22 and the outside air suction port 23 selectively is provided in the most upstream portion of the air conditioning case 21. The inside air suction port 22, the outside air suction port 23, and the suction port opening/closing door 24 configure an inside air/outside air switching part that selects the inside air or the outside air as a suction air drawn into the air conditioning case 21. An operation of the suction port opening/closing door 24 is controlled by a control signal output from a controller that is not shown.

A blower 25 as a blowing device that blows air into the vehicle compartment is arranged on a downstream side of the suction port opening/closing door 24 in the flow direction of air. The blower 25 of the present embodiment is an electric blower of which centrifugal multi-blade fan 25a is driven by an electric motor 25b as a drive source, and a rotation speed (i.e., a volume of air to blow) is controlled by a control signal output from the controller that is not shown.

An evaporator 26 that functions as a cooler cooling air blown by the blower 25 is arranged on a downstream side of the blower 25 in the flow direction of air. The evaporator 26 is a heat exchanger that performs a heat exchange between refrigerant flowing therethrough and air and configures a vapor-compression type refrigerant cycle together with a compressor, condenser, and an expansion valve that are not shown.

A heater core 27 that functions as a heater heating air after being cooled in the evaporator 26 is arranged on a downstream side of the evaporator 26 in the flow direction of air. The heater core 27 of the present embodiment is a heat exchanger that heats air using engine cooling water for a vehicle engine as a heat source. The evaporator 26 and the heater core 27 configure a temperature adjuster that adjusts a temperature of air to be blown into the vehicle compartment.

A cool air bypass passage 28 that guides air after passing through the evaporator 26 to bypass the heater core 27 is provided on a downstream side of the evaporator 26.

A temperature of air mixed on a downstream side of the heater core 27 and the cool air bypass passage 28 is changed by a ratio between a volume of air passing through the heater core 27 and a volume of air passing through the cool air bypass passage 28.

Therefore, an air mix door 29 is arranged on the downstream side of the evaporator 26 in the flow direction of air and on an inlet side of the cool air bypass passage 28. The air mix door 29 continuously changes a ratio between cool air flowing into the heater core 27 and cool air flowing into the cool air bypass passage 28 and functions as the temperature adjuster together with the evaporator 26 and the heater core 27. An operation of the air mix door 29 is controlled by a control signal output from the controller.

A defroster/face opening 30 and a foot opening 31 are provided on a most downstream side of the air conditioning case 21 in the flow direction of air. The defroster/face opening 30 is connected, through the duct 12, to the blowing outlet 11 provided in the upper surface 1a of the instrument panel 1. The foot opening 31 is connected to a foot blowing outlet 33 thorough a foot duct 32.

A defroster/face door 34 that opens or closes the defroster/face opening 30 is arranged on an upstream side of the defroster/face opening 30 in the flow direction of air. A foot door 35 that opens or closes the foot opening 31 is arranged on an upstream side of the foot opening 31 in the flow direction of air.

The defroster/face door 34 and the foot door 35 is a blowing mode door that switches a blowing state of air to be blown into the vehicle compartment.

The airflow deflection door 13 is operated synchronizing with the blowing mode doors 34, 35 to set a required blowing mode. An operation of the airflow deflection door 13 and the blowing mode doors 34, 35 is controlled by a control signal output from the controller. Positions of the airflow deflection door 13 and the blowing mode doors 34, 35 are changeable by a manual operation by the passenger.

For example, the defroster/face door 34 closes the defroster/face opening 30, and the foot door 35 opens the foot opening 31, when the foot mode blowing air from the foot blowing outlet 33 toward foot of the passenger. On the other hand, the defroster/face door 34 opens the defroster/face opening 30, and the foot door 35 closes the foot opening 31, when one of the defroster mode, the upper vent mode and the face mode is operated. In this case, the airflow deflection door 13 is positioned at a position corresponding to a required blowing mode.

According to the present embodiment, a position of the airflow deflection door 13 is changed by moving the airflow deflection door 13 in the front-rear direction. Thereby a blowing angle θ is change by changing an airflow velocity in the front path 12a and an airflow velocity in the rear path 12b. The blowing angle θ is an angle formed by a blowing direction with the vertical direction as shown in FIG. 1. The vertical direction is set as a base direction since the blowing direction of air from the blowing outlet 11 in a case that the airflow deflection door 13 is not provided in the duct 12 is the vertical direction.

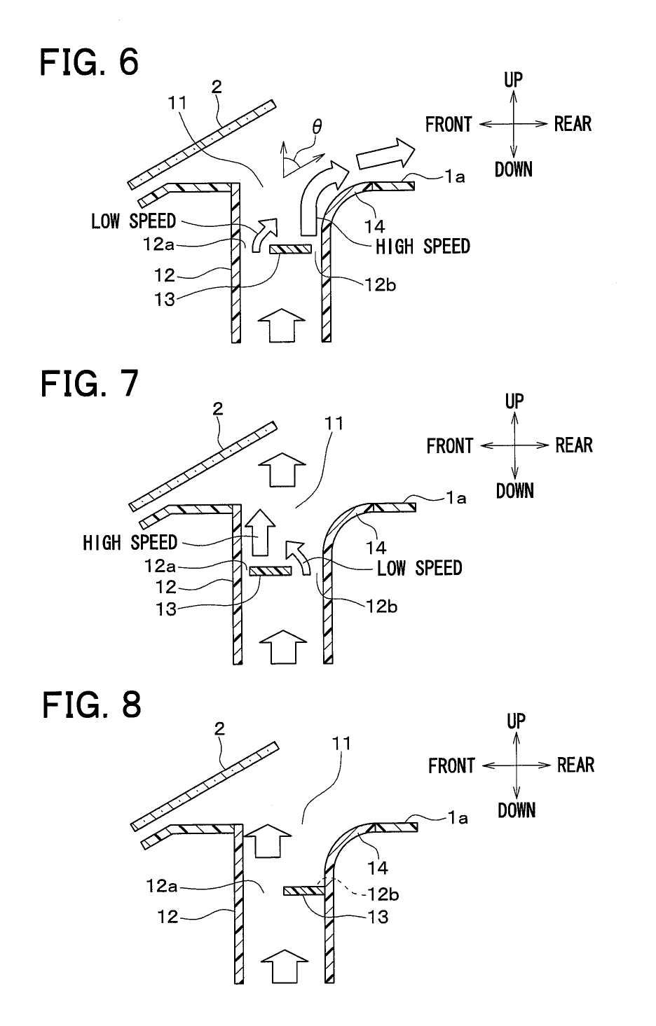

As shown in FIG. 6, the airflow deflection door 13 is located on a rear side when the blowing mode is the face mode such that a passage sectional area of the rear path 12b becomes relatively small and a passage sectional area of the front path 12a becomes relatively large. Accordingly, the first state, in which the high-speed airflow is generated in the rear path 12b and the low-speed airflow is generated in the front path 12a, is set. The high-speed airflow is bent rearward by flowing along the guide wall 14 by Coanda effect. As a result, air of which temperature is adjusted in the air conditioning unit 20, for example, cool air blows from the blowing outlet 11 toward the upper body of the passenger. At this time, a velocity ratio between the high-speed airflow and the low-speed airflow can be adjusted by changing a position of the airflow deflection door 13 manually by the passenger or automatically by the controller. Thus, the blowing angle θ in the face mode can be set at a required angle.

As shown in FIG. 7, the airflow deflection door 13 is located on a front side when the blowing mode is the defroster mode such that a passage sectional area of the front path 12a becomes relatively small, and a passage sectional area of the rear path 12b becomes relatively large. Accordingly, the second state, in which the high-speed airflow is generated in the front path 12a and the low-speed airflow is generated in the rear path 12b, is set. In the second state, the high-speed airflow flows upward along the front wall of the duct 12. As a result, air of which temperature is adjusted in the air conditioning unit 20, for example, warm air blows from the blowing outlet 11 toward the windshield 2. At this time, the velocity ratio between the high-speed airflow and the low-speed airflow can be adjusted by changing a position of the airflow deflection door 13 manually by the passenger or automatically by the controller. Thus, the blowing angle θ in the face mode can be set at a required angle.

The airflow deflection door 13 is located between the position of the airflow deflection door 13 in the face mode and the position of the airflow deflection door 13 in the defroster mode when the blowing mode is the upper vent mode. Although the first state is also set in this case, the blowing angle θ becomes smaller than the blowing angle θ in the face mode since a speed of the high-speed airflow is lower than that in the face mode. As a result, air of which temperature is adjusted in the air conditioning unit 20, for example, cool air blows from the blowing outlet 11 toward the passenger having the rear seat.

Thus, the upper vent mode is realized by adjusting the velocity ratio between the high-speed airflow and the low-speed airflow by changing the ratio between the sectional area of the rear path 12b and the sectional rear of the front path 12a with respect to the face mode by the airflow deflection door 13. The blowing angle can be set to a required angle in the upper vent mode in a manner that the passenger manually adjusts the position of the airflow deflection door 13 or the controller automatically adjusts the position of the airflow deflection door 13 to adjust the velocity ratio between the high-speed airflow and the low-speed airflow.

The airflow deflection door 13 may be positioned as shown in FIG. 8 when the blowing mode is the defroster door. In FIG. 8, the airflow deflection door 13 is positioned to fully close the rear path 12b and fully open the front path 12a. In this case, the second state different from the first state, in other words, a state in which air flows only in the front path 12a, and in which the high-speed airflow is not generated in the rear path 12b is set. Accordingly, warm air blows from the blowing outlet 11 toward the windshield 2. Alternatively, the airflow deflection door 13 may be positioned at a position opposite from the position shown in FIG. 8 to fully close the front path 12a and fully open the rear path 12b. In this case, the second state in which air flows only in the front path 12a, and in which the high-speed airflow is not generated in the rear path 12b. As a result, warm air blows from the blowing outlet 11 toward the windshield 2.

An effect provided by the present embodiment will be described hereinafter.

(1) According to the air-blowing device of Patent Literature 1, the high-speed airflow is bent, and the blowing direction of air from a blowing outlet is changed, only by guiding the airflow (i.e., a jet flow) from the nozzle to flow along the guide wall. Therefore, the airflow cannot be bent largely, and the air may not be blown toward the upper body of the passenger having the front seat in the face mode.

On the other hand, according to the present embodiment, the high-speed airflow is generated in the rear path 12b, and the low-speed airflow is generated in the front path 12a, in the face mode. On this occasion, a negative pressure is caused on a downstream side of the airflow deflection door 13 by the high-speed airflow. As a result, the low-speed airflow is drawn into the downstream side of the airflow deflection door 13 and joins to the high-speed airflow while being bent toward the high-speed airflow. Therefore, as compared to Patent Literature 1, the air flowing in the duct 12 can be bent largely toward a rear side, and a largest bending angle θ of air blowing from the blowing outlet 11 can be large. Thus, the air can be blown toward the upper body of the passenger having the front seat.

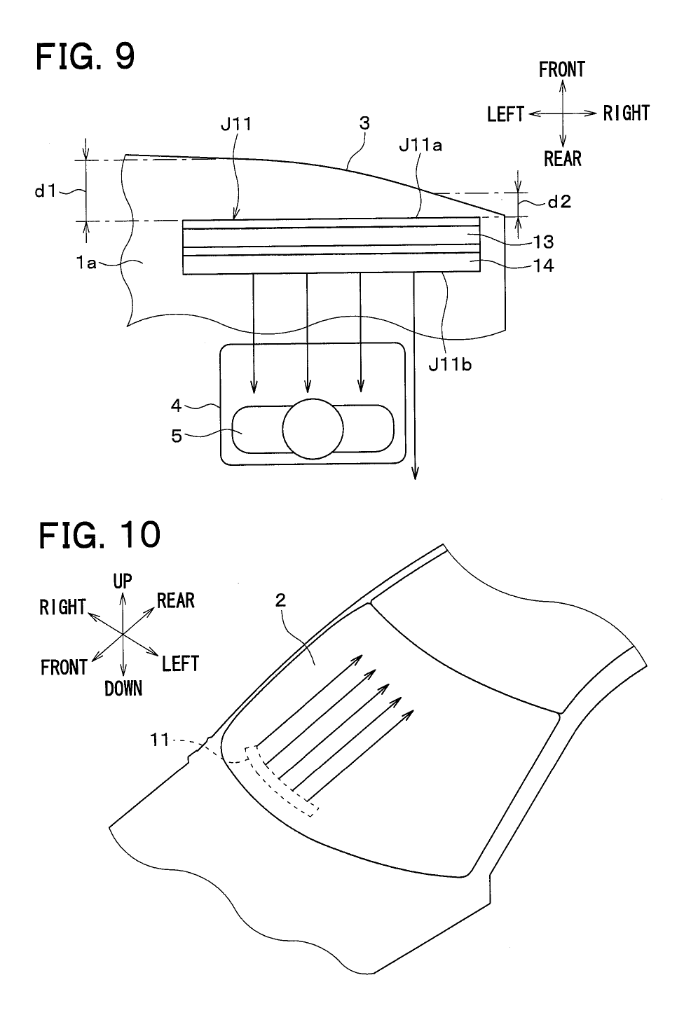

(2) According to a first comparable example shown in FIG. 9, a blowing outlet J11 extends straight in the lateral direction. In this case, there is a fear that only air from a portion of the blowing outlet J11 located in front of the passenger in the front-rear direction reaches to the passenger 5 in the face mode blowing air from the blowing outlet J11 toward the passenger 5 as the target. That is, there is a fear that air from another portion of the blowing outlet J11 other than the portion located in front of the passenger does not reach the passenger 5. In the air-blowing device of the first comparable example, only a shape of the blowing outlet J11 is different from the present embodiment, and other configurations are the same as the present embodiment.

Air flowing out of the duct 12 through the blowing outlet flows along the guide wall 14. Therefore, the blowing direction of air from the blowing outlet 11 is set by a shape of the long edge 11b (i.e., the edge) included in the opening peripheries 11a-11d of the blowing outlet 11 and connected to the guide wall 14. That is, the blowing direction of the air is a perpendicular direction that is perpendicular to the long edge 11b of the opening periphery connected to the guide wall. The perpendicular direction of the long edge 11b is a direction perpendicular to the long edge 11b when the long edge 11b has a straight shape, and the perpendicular direction of the long edge 11b is a direction perpendicular to a tangential line tangent to the long edge 11b when the long edge 11b has a curved shape.

According to the first comparable example, the opening periphery of the blowing outlet J11 has the long edge 11b connected to the guide wall 14, and the long edge 11b extends straight in the lateral direction. Therefore, as shown in FIG. 9, air is blown parallel from the blowing outlet J11 toward the rear side.

On the other hand, according to the present embodiment as shown in FIG. 4, the opening periphery of the blowing outlet 11 blowing air in the face mode has the long edge 11b connected to the guide wall 14, and the long edge 11b is curved to protrude frontward (i.e., protrude in the direction from the first wall toward the second wall). Accordingly, as compared to the first comparable example, air from the blowing outlet 11 can be converged and concentrated on the passenger 5.

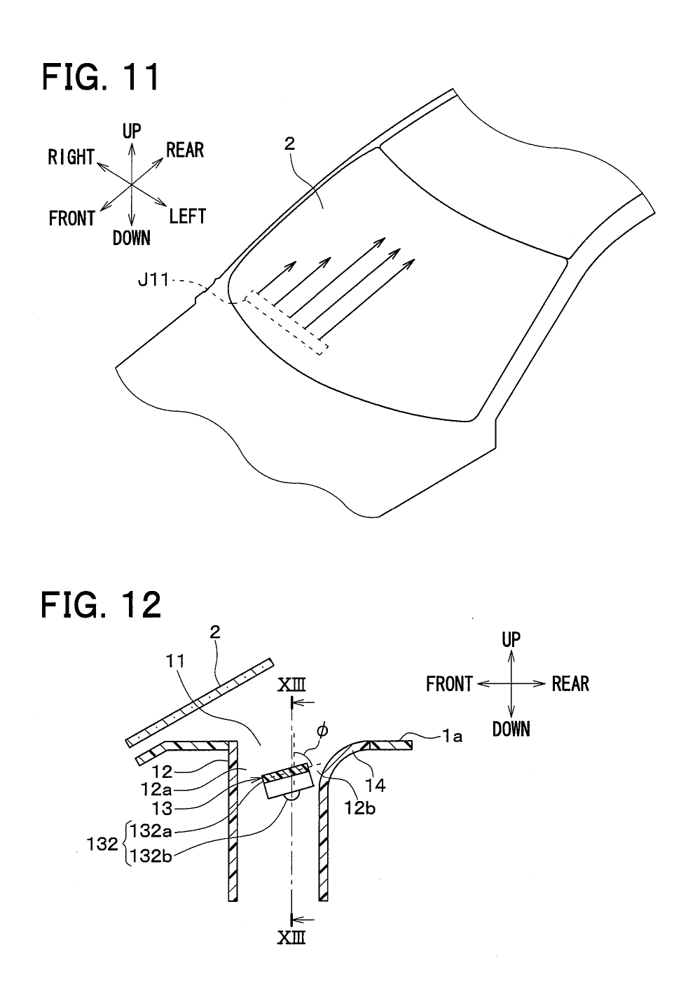

(3) In a case of the first comparable example shown in FIG. 9, a dimension between a long edge J11a that is a front edge of the opening periphery and the boundary 3 becomes non-uniform since the blowing outlet 11 extends straight in the lateral direction. That is, regarding the dimension between the boundary 3 and the long edge J11a that is the front edge of the opening periphery, a dimension d1 in a center area of the vehicle becomes large, and a dimension d2 on a side adjacent to a door becomes small, since the boundary 3 has a curved shape protruding frontward. As a result, as shown in FIG. 11, arrival sites in the windshield 2, which air from a portion of the blowing outlet J11 on the side adjacent to the door and air from a portion of the blowing outlet J11 in the center area reach in the defroster mode, are different from each other. As a result, an area of the windshield 2 defogged by the air becomes uneven.

On the other hand, according to the present embodiment, the opening periphery of the blowing outlet 11 has, as the front edge, the long edge 11a having a curved shape extending parallel with the boundary 3, and the dimension dx between the boundary 3 and the long edge 11a that is the front edge of the opening periphery is uniform. Therefore, as shown in FIG. 10, the arrival sites in the windshield 2, which the air reaches in the defroster mode, can be even, and the area defogged by the air can be prevented from being uneven.

### Second Embodiment

According to an air-blowing device 10 of the present embodiment, a butterfly door 132 is used as the airflow deflection door 13 as shown in FIG. 12. Other configurations are the same as the first embodiment.

The butterfly door 132 has a door body 132a having a plate shape and a rotary shaft 132b that is provided in a center portion of the door body 132a. A length of the door body 132a in the front-rear direction is shorter than a length of the duct 12 in the front-rear direction. Accordingly, the duct 12 is not closed even when the butterfly door 132 is positioned horizontally. The rotary shaft 132b is located on a rear side of a center of the duct 12 in the front-rear direction. As a result, a sectional area of the rear path 12b becomes small, and the high-speed airflow is generated in the rear path 12b.

According to the present embodiment, the ratio between the sectional area of the front path and the sectional area of the rear path 12b is changed by rotating the butterfly door 132 and changing a door angle φ of the butterfly door 132. The door angle φ is an angle formed by the door body 132a with a central axis of the duct 12. According to the present embodiment, the central axis of the duct 12 extends in the vertical direction. As a result, similar to the first embodiment, the blowing angle θ is changed by changing the airflow velocity in the front path 12a and the airflow velocity in the rear path 12b. For example, the door angle φ is set to be an obtuse angle, for example, in a range of 50o to 60o such that the sectional area of the rear path 12b becomes small when the blowing mode is the face mode. FIG. 12 shows a position (i.e., a direction) of the butterfly door 132 in the face mode.

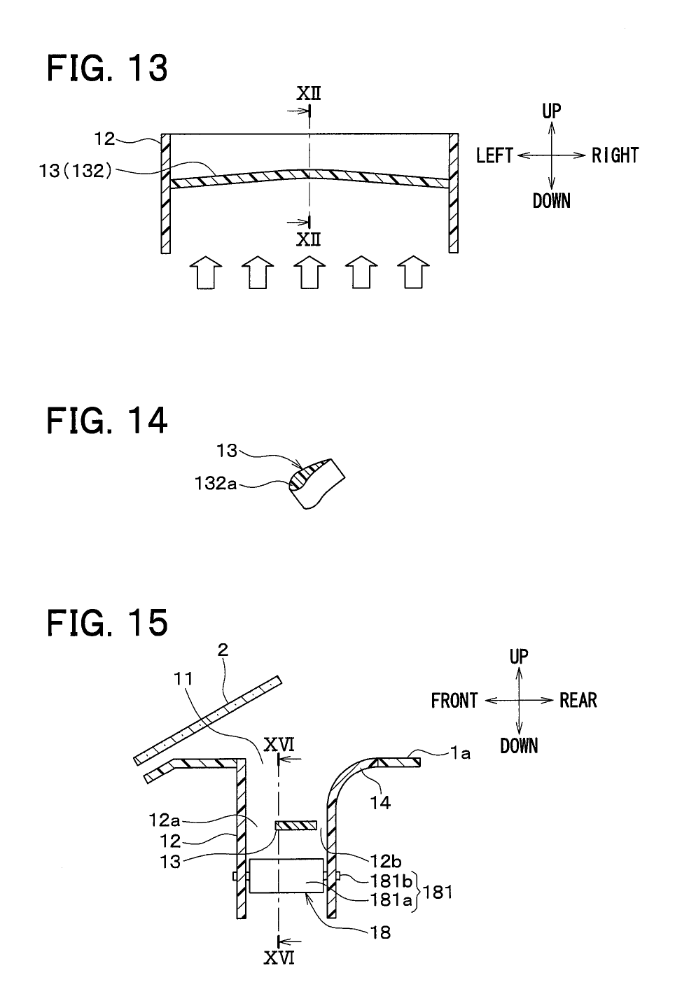

The door body 132a is curved to protrude frontward (i.e., extends to have a shape protruding in a direction) similar to the blowing outlet 11 shown in FIG. 4 when the butterfly door 132 is positioned to perform the face mode. Furthermore, the door body 132a is curved to protrude toward a downstream side in the duct 12 in the flow direction of air (i.e., upward in FIG. 13) as shown in FIG. 13. A dimension between the door body 132a and the guide wall 14 can be uniform or approximately uniform since the door body 132a is curved to protrude in the blowing direction of air blowing from the blowing outlet 11. In addition, air can flow easily along a surface of the door body 132a as compared to a case that the door body 132a has a flat shape, since the door body 132a is curved to protrude toward the downstream side in the duct 12 in the flow direction of air. As a result, a resistance (i.e., a ventilation resistance) caused when air passes the butterfly door 132.

According to the present embodiment, the door body 132a of the butterfly door 132 has a rectangular shape in cross section. However, as shown in FIG. 14, the resistance caused when air passes the butterfly door 132 can be further reduced when the door body 132a has a streamline shape in cross section. The streamline shape is a shape that prevents air flowing around the butterfly door 132 from separating from the butterfly door 132 on a rear edge side of the butterfly door 132. According to an example shown in FIG. 14, the streamline shape of the door body 132a is a droplet shape in which a width gradually increases from a tip in the flow direction of air, and subsequently decreases toward the rear edge side.

### Third Embodiment

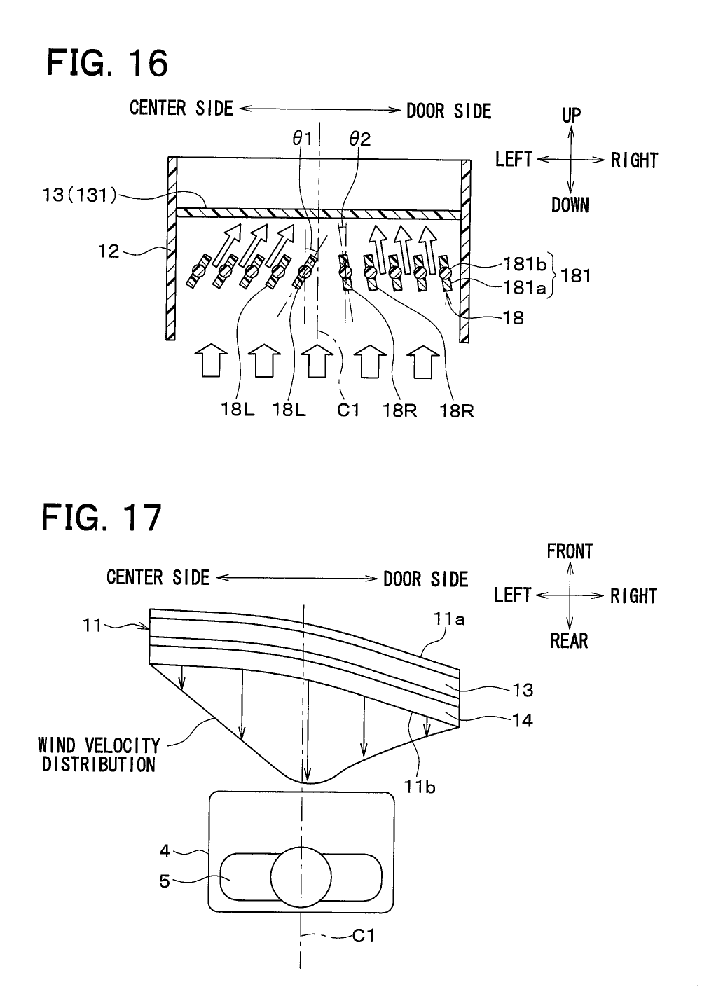

According to an air-blowing device 10 of the present embodiment, an adjuster 18 is provided inside the duct 12 as shown in FIG. 15 and FIG. 16. Other configurations are the same as the first embodiment, and a shape of the blowing outlet 11 is, as shown in FIG. 17, the same as the shape of the blowing outlet 11 shown in FIG. 4.

The adjuster 18 adjusts the flow direction of air blowing from the blowing outlet 11 in the lateral direction by adjusting the flow direction of air in the duct 12 in the lateral direction.

As shown in FIG. 15 and FIG. 16, the adjuster 18 is located on an upstream side of the airflow deflection door 13 inside the duct 12 in the flow direction of air. The adjuster 18 has plate members 18L, 18R. According to the present embodiment, each of the plate members 18L, 18R is configured by a butterfly door 181 that has a door body 181a having a plate shape and a rotary shaft (i.e., rotation axis) 181b provided in a center portion of the door body 181a. The rotary shaft 181b extends parallel with the front-rear direction (i.e., a direction in which the first wall and the second wall face each other).

As shown in FIG. 16, the plate members 18L, 18R are arranged one after another in the lateral direction (i.e., one direction). Each of the plate members 18L, 18R rotates around the rotary shaft 181b. The plate members 18L, 18R includes a first plate member 18L that is located on a left side of a base point C1 in the lateral direction (i.e., one side in the one direction) and a second plate member 18R that is located on a right side of the base point C1 in the lateral direction (i.e., the other side in the one direction). The base point C1 will be described later. The plate members 18L, 18R can face in the same direction, or the first plate member 18L and the second plate member 18R can face in different directions from each other. Accordingly, although not shown, for example, air can blow from the blowing outlet 11 toward one side in the lateral direction by positioning the plate members 18L, 18R to face in the same direction and by turning the plate members 18L, 18R toward the one side in the lateral direction in the face mode.

Alternatively, as shown in FIG. 16, the first plate member 18L located on the left side of the base point C1 (i.e., on a center side in the vehicle) is inclined rightward with respect to the center axis of the duct 12, and the second plate member 18R located on the right side of the base point C1 (i.e., on the side adjacent to the door) is inclined leftward with respect to the center axis of the duct 12. That is, the first plate member 18L and the second plate member 18R are respectively inclined inward in the duct 12. In other words, the first plate member 18L and the second plate member 18R are respectively inclined to approach the base point C1 as extending from an upstream side to a downstream side in the flow direction of air (i.e., as extending upward). In the face mode, air blows from the blowing outlet 11 toward the seat 4 located on a rear side of the blowing outlet 11. The base point C1 is a location corresponding to a center of the seat 4, which is the target to which air flows toward in the face mode, in the front-rear direction. In other words, the center point C1 is located in the duct 12 and faces the center of the seat 4, which is located away from the blowing outlet 11 in the direction from the second wall toward the first wall, when air blows from the blowing outlet 11 toward the seat 4.

According to the present embodiment, a direction of the center axis of the duct 12 coincides with the vertical direction (i.e., the upper-lower direction). In addition, according to the present embodiment, the lateral direction generally coincides with the one direction in which the blowing outlet 11 extends. Further, the left side (i.e., the center side in the vehicle) coincides with the one side in the one direction, and the right side (i.e., the side adjacent to the door) coincides with the other side in the one direction.

Accordingly, air flowing in the duct 12 flows inward in the duct 12 by flowing along a surface of each of the plate members 18L, 18R of the adjuster 18. As a result, as shown in FIG. 17, the air from the blowing outlet 11 can be concentrated to the center in the lateral direction. In other words, the velocity distribution in which a velocity of air blowing from a center portion of the blowing outlet 11 in the lateral direction is higher than a velocity of air blowing from a portion of the blowing outlet 11 located outer side of the center portion of the blowing outlet 11 in the lateral direction can be provided.

A relationship between a first angle θ1 and a second angle θ2 shown in FIG. 16 will be described. The first angle θ1 is defined as an angle formed by the first plate member 18L with an axial direction of the duct 12, and the second angle θ2 is defined as an angle formed by the second plate member 18R with the axial direction of the duct 12. The first angle θ1 and the second angle θ2 are respectively an angle that is formed by the adjuster with the axial direction of the duct 12 and faces toward the downstream side in the flow direction of air.

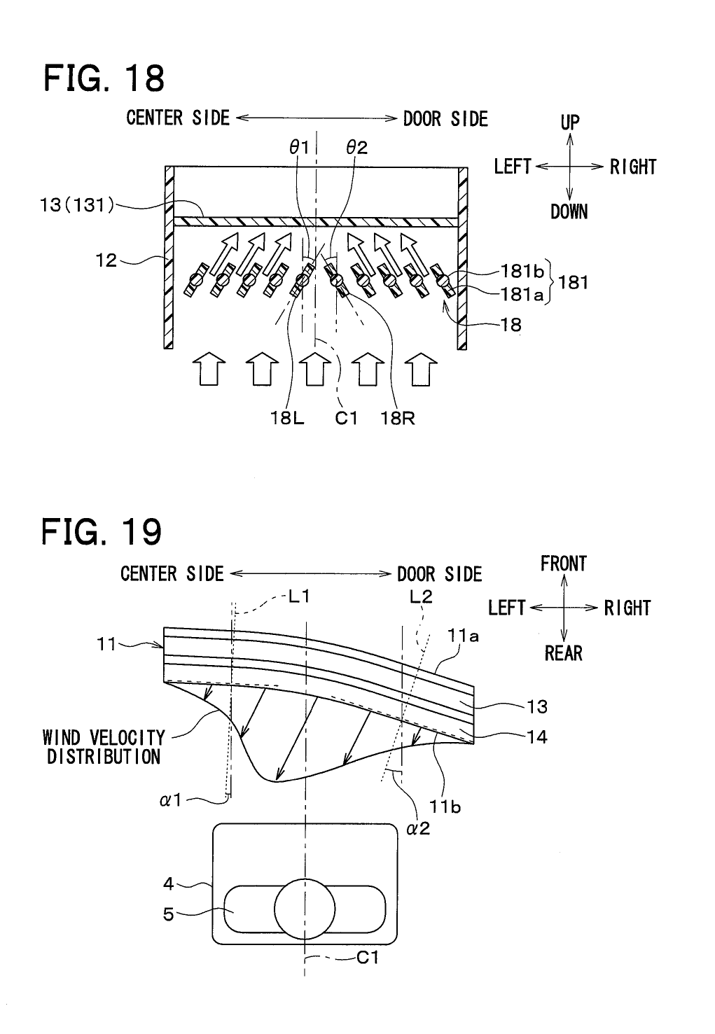

As shown in a second comparable example shown in FIG. 18, a velocity distribution of air from the blowing outlet 11 becomes a velocity distribution shown in FIG. 19 in the face mode by an influence of the shape of the blowing outlet 11, in a case that the first angle θ1 and the second angle θ2 are equal to each other (θ1=θ2), in contrast to the present embodiment.

Specifically, according to the blowing outlet 11 of the present embodiment, the blowing direction in a portion of the blowing outlet 11 on a side of the base point C1 adjacent to the center is different from the blowing direction in a portion of the blowing outlet 11 on the side adjacent to the door. That is, an inclination angle α1 formed by a perpendicular line L1 of the long edge 11b with the front-rear direction is small in a portion of the long edge 11b of the opening periphery that is located on the side of the base point C1 adjacent to the center, and an inclination angle α2 formed by a perpendicular line L2 of the long edge 11b with the front-rear direction is large in a portion of the long edge 11b of the blowing outlet 11 on the side of the base point C1 adjacent to the door. The perpendicular line of the long edge 11b is a line perpendicular to the tangential line of the long edge 11b. Therefore, the blowing direction of air blowing from a portion of the blowing outlet 11 on the side of the base point C1 adjacent to the center is a rear direction, and the blowing direction of air blowing from a portion of the blowing outlet 11 on the side of the base point C1 adjacent to the door inclines toward the center than the rear side, in a case that the flow direction of air flowing in the duct 12 is the axial direction of the duct 12.

The air from the blowing outlet 11 is concentrated to a position shifted to the center side rather than the passenger 5 in response to the influence of the shape of the long edge 11b of the opening periphery in a portion on the side of the base point C1 adjacent to the door when the first angle θ1 is equal to the second angle θ2.

Then, according to the present embodiment, as shown in FIG. 16, the first angle θ1 is larger than the second angle θ2 (θ1>θ2). Specifically, the first angle θ1, which is formed by the first plate member 18L located on a side less affected by the shape of the blowing outlet 11, is set to be large, and the second angle θ2, which is formed by the second plate member 18R located on a side deeply affected by the shape of the blowing outlet 11, is set to be small.

Accordingly, as shown in FIG. 17, the air from the blowing outlet 11 can be concentrated to the passenger 5 having the seat 4. That is, a wind velocity in which a speed of air flowing in a direction from the blowing outlet 11 toward the passenger 5 becomes highest can be provided.

In the face mode, the high-speed airflow generated by the airflow deflection door 13 flows along the guide wall 14 that curves from the first wall to be away from the second wall. Accordingly, air blows from the blowing outlet 11 toward the passenger. Therefore, the high-speed airflow generated by the airflow deflection door 13 flows along the adjuster 18, and a bent degree of air flowing along the guide wall 14 may become small, in a case that the adjuster 18 is located on the downstream side of the airflow deflection door 13 in the flow direction of air. In other words, the high-speed airflow generated by the airflow deflection door 13 hardly flows along the guide wall 14 since the high-speed airflows flows along the adjuster 18.

Then, according to the present embodiment, the adjuster 18 is located on the upstream side of the airflow deflection door 13 in the flow direction of air such that a flow direction of air is adjusted in the lateral direction before the airflow deflection door 13 generates the high-speed airflow. Therefore, the high-speed airflow generated by the airflow deflection door 13 flows along the guide wall 14, and a decrease of the bent degree of the air flowing along the guide wall 14 can be suppressed.

According to the present embodiment, the adjuster 18 is configured by the butterfly door. However, the adjuster 18 may be configured by a cantilever door that has a door body having a plate shape and a rotary shaft provided in one end portion of the door body.

### Fourth Embodiment

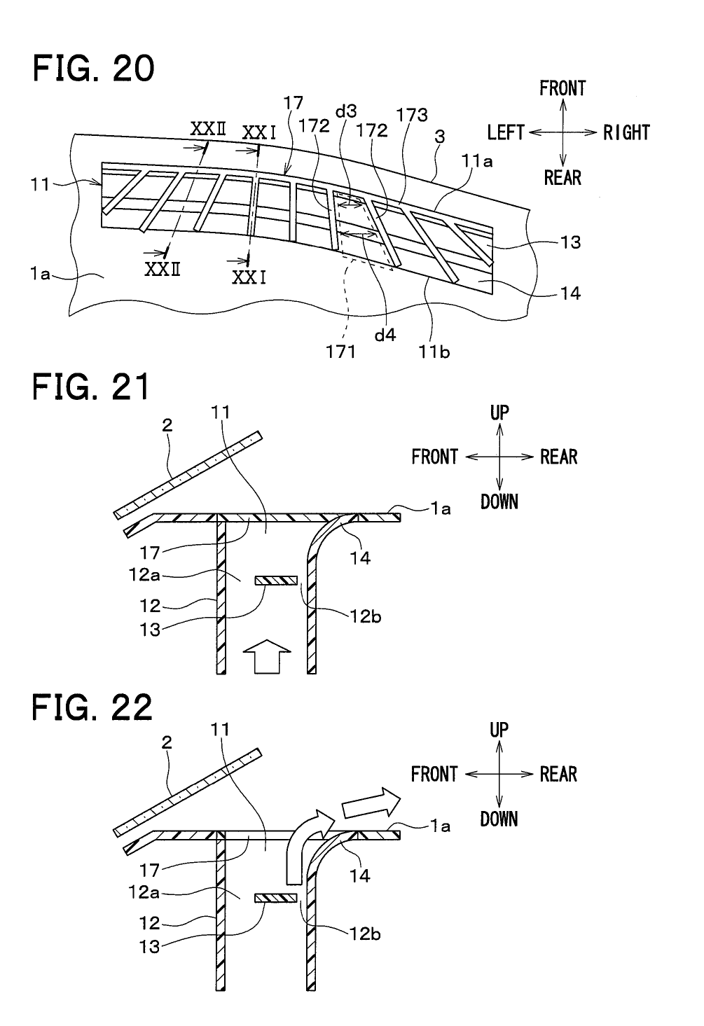

According to the present embodiment, as shown in FIGS. 20 through 22, a cover 17 is provided in the upper surface 1a of the instrument panel 1 to cover the blowing outlet 11. Other configurations are the same as the first embodiment.

The cover 17 is a foreign particle intrusion prevention member that restricts an intrusion of a foreign particle from the blowing outlet 11 into the duct 12. The cover 17 has slits 171 extending in the front-rear direction. Each of the slits 171 is an opening elongated in one direction. The cover 17 is, specifically, has a comb shape and has elongated portions 172 corresponding to teeth and a connection portion 173 connecting the elongated portions 172 with each other. The elongated portions 172 extend rearward from the connection portion 173, and the connection portion 173 extends parallel with the lateral direction. The slit 171 is formed between adjacent two of the elongated portions 172. Therefore, according to the present embodiment, the elongated portions 172 are slit forming portions that form the slits 171. Plate members may be used instead of the elongated portions 172 as the slit forming portions. In this case, the slit is formed between adjacent two of the plate members.

According to the present embodiment, a dimension d3 between the adjacent two of the elongated portions 172 on a front side is smaller than a dimension d4 between the adjacent two of the elongated portions 172 on a rear side.

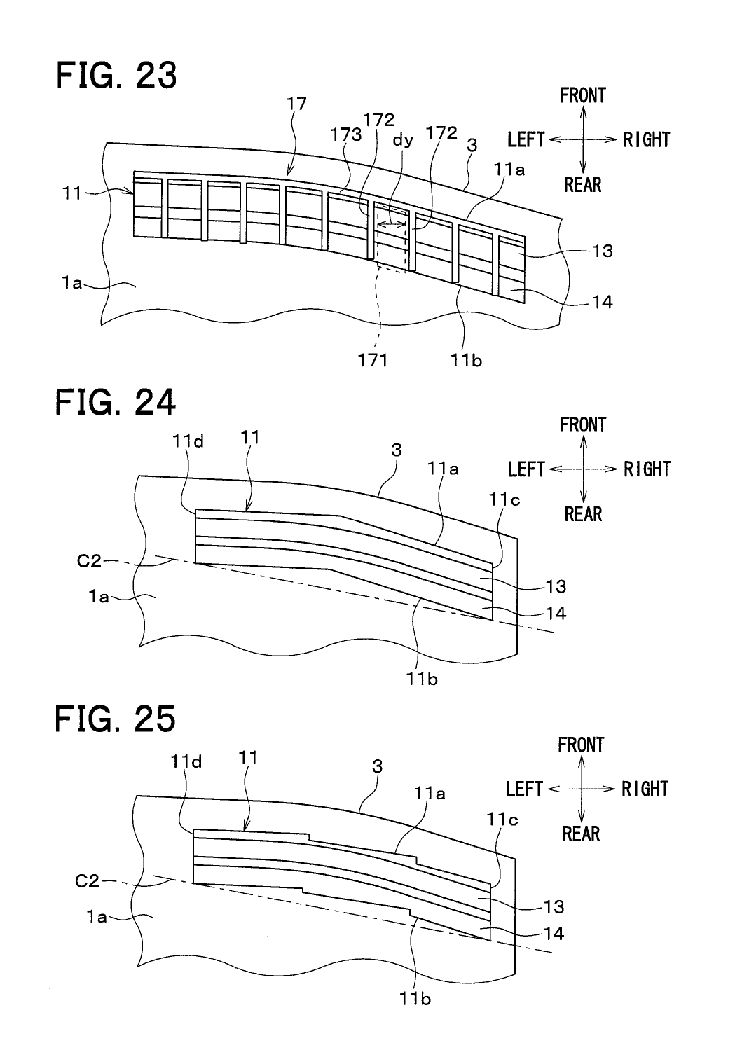

In contrast to the present embodiment, it is difficult to achieve both of increasing an accuracy of air to reach the windshield 2 in the defroster mode and securing a comfortable feeling of the passenger in the face mode in a case that a dimension dy between adjacent two of the elongated portions 172 is even in an entire area in the front-rear direction as a third comparable example shown in FIG. 23.

That is, a speed of air blowing from the blowing outlet 11 is required to be high such that the air reaches a site far away from the blowing outlet 11 so as to defog the windshield 2. In this point of view, the accuracy of air to reach the windshield 2 in the defroster mode can be improved by decreasing the dimension dy between adjacent two of the elongated portion 172 and increasing the speed of air blowing from the blowing outlet 11. However, in this case, the passenger may feel uncomfortable since a speed of air flowing toward the passenger increases in the face mode.

In contrast, the comfortable feeling of the passenger can be secured by increasing the dimension dy between adjacent two of the elongated portions 172 and restricting an increase of the speed of air blowing from the blowing outlet 11. However, in this case, the air may not reach the site in the windshield 2 far away from the blowing outlet 11 since the speed of air blowing from the blowing outlet 11 decreases in the defroster mode.

In contrast, according to the present embodiment, the dimension d3 between adjacent two of the elongated portions 172 on the front side is smaller than the dimension d4 between the adjacent two of the elongated portions 172 on the rear side. According to the air-blowing device 10 of the present embodiment, similar to the first embodiment, air flows from a front portion of the blowing outlet 11 in the defroster mode, and air flows from the front portion of the blowing outlet 11 in the face mode. As a result, according to the present embodiment, a speed of air blowing from the blowing outlet 11 can be increased in the defroster mode while decreasing the speed of air blowing from the blowing outlet 11 in the face mode. Therefore, according to the present embodiment, it is easy to achieve both of increasing an accuracy of air to reach the windshield 2 in the defroster mode and securing a comfortable feeling of the passenger in the face mode.

(Other Modifications)

The present disclosure is not limited to the above-described embodiments and can be modified within the scope of the present disclosure.

(1) According to the first embodiment, the opening periphery of the blowing outlet has the long edge 11b as the rear edge, and the long edge 11b has a curved shape extending parallel with the boundary 3. However, the long edge 11b is not limited to have the curved shape as long as extending to have a shape protruding in the direction from the first wall toward the second wall of the duct 12. For example, the long edge 11b may have a polygonal line shape as shown in FIG. 24 or a stepped shape as shown in FIG. 25. The shape protruding in the direction from the first wall toward the second wall of the duct 12 is a shape in which a center of the long edge 11b in the lateral direction is located on an opposite side (i.e., an upper side in FIG. 24 and FIG. 25), in the blowing direction, with respect to a base line C2 connecting both lateral ends of the long edge 11b to each other.

(2) According to the first embodiment, the opening periphery of the blowing outlet 11 has the long edge 11a as a front edge, and the long edge 11a has a curved shape parallel with the boundary 3. However, the long edge 11a is not limited to have the curved shape as long as extending along the boundary 3. For example, the long edge 11a may have a polygonal line shape as shown in FIG. 24 or a stepped shape as shown in FIG. 25. When it is said that the long edge 11a extends along the boundary 3, it means that the dimension between the long edge 11a as the front edge of the opening periphery and the boundary 3 is approximately even in an entirety of the long edge 11a, for example, a difference between a largest dimension and a smallest dimension is in a range of about 10%.

(3) According to the above-described embodiments, a wall surface of the guide wall 14 is curved to protrude toward an inside of the duct 12. However, a shape of the guide wall 14 is not limited to the shape explained in the above-described embodiments as long as having a shape that is able to guide an airflow in the duct 12 to bent rearward along the wall surface by Coanda effect to be blown rearward from the blowing outlet 11. For example, the guide wall 14 may have a flat plane shape. In this case, a passage width of the duct 12 gradually increases toward the downstream side in the flow direction of air. Alternatively, the wall surface may have a stepped shape having steps. In this case, the passage width of the duct 12 gradually increases toward the downstream side in the flow direction of air.

(4) According to the above-described embodiments, the blowing direction of air blowing from the blowing outlet 11 is changed by changing the ratio between the sectional area of the rear path 12b and the sectional area of the front path 12a using the airflow deflection door 13. However, for example, a nozzle generating a high-speed airflow and a control air blowing portion that blows a control air to guide the high-speed airflow from the nozzle to approach one side as described in Patent Literature 1. In this case, the blowing direction of air blowing from the blowing outlet 11 is change by guiding the high-speed airflow to approach one side or the other side.

(5) The air-blowing device 10 of the above-described embodiments has a configuration that changes the blowing direction of air blowing from the blowing outlet 11. However, the air-blowing device 10 may have a configuration that does not change the blowing direction of air. That is, the air-blowing device of the present disclosure may have a configuration that constantly blows air from the blowing outlet 11 while the air is being bent along the guide wall 14 when the air blows from the blowing outlet 11.

(6) According to the above-described embodiments, the opening peripheries 11a-11d of the blowing outlet 11 is formed directly in the upper surface 1a of the instrument panel 1. However, in a case that the upper surface 1a has an opening, and the opening is closed by a wall portion, the opening peripheries 11a-11d of the blowing outlet 11 may be formed in the wall portion. In this case, the wall portion that closes the opening configures the wall portion provided with the opening peripheries 11a-11d.

(7) According to the above-described embodiments, the blowing outlet is located in the upper surface 1a of the instrument panel 1. However, the blowing outlet may be located in another position. For example, the blowing outlet may be provided with a lower surface of the instrument panel 1. That is, the blowing outlet of the air-blowing device according to the present disclosure may be used as a foot blowing outlet. In this case, a blowing angle of air blowing from the foot blowing outlet can be changed as required. In addition, according to the above-described embodiments, the air-blowing device of the present disclosure is used for a vehicle air conditioner. However, the air-blowing device may be used for a household air conditioner.

(8) The above-described embodiments are not unrelated to each other and can be combined with each other except for a case where the combination is clearly improper. In the above-described embodiments, it is to be understood that elements constituting the embodiments are not necessary except for a case of being explicitly specified to be necessary and a case of being considered to be absolutely necessary in principle.

What is claimed is:

1. Air-blowing device comprising:
a wall portion that is provided with a blowing outlet having an opening periphery extending in one direction;
a duct that has a first wall and a second wall facing the first wall and therein provides an air passage communicating with the blowing outlet; and
a guide wall that curves from the first wall to be away from the second wall, the guide wall that is connected with an edge providing the opening periphery, the guide wall that guides air flowing in the air passage to blow from the blowing outlet in a direction from the second wall toward the first wall, wherein
the edge extends to have a shape protruding in a direction from the first wall toward the second wall.

2. The air-blowing device according to claim 1, further comprising
an adjuster that is provided inside the duct and adjusts a flow direction of air flowing in the air passage, wherein
the adjuster has plate members that are arranged one after another in the one direction and rotate around axes respectively, and the axes are parallel with a direction in which the first wall and the second wall face each other,
the plate members:
include a first plate member located on one side of a base point in the one direction and a second plate member located on an other side of the base point in the one direction, when the base point is defined as a location that faces a center of a target positioned away from the blowing outlet in the direction from the second wall toward the first wall; and
are inclined such that the first plate member and the second plate member respectively approach the base point as extending from an upstream side to a downstream side in the flow direction of air when the air blows from the blowing outlet toward the target, and
a first angle formed by the first plate member with an axial direction of the duct is larger than a second angle formed by the second plate member with the axial direction of the duct.

3. The air-blowing device according to claim 1, further comprising
an airflow deflector that is provided inside the duct, wherein
the air passage includes a first path provided between the airflow deflector and the first wall and a second path provided between the airflow deflector and the second wall,
the airflow deflector (i) generates a high-speed airflow in the first path by decreasing a sectional area of the first path to be smaller than a sectional area of the second path and (ii) switches between a first state in which a low-speed airflow is generated in the second path and a second state in which an airflow that is different from the low-speed airflow generated in the first state is generated inside the duct, and
the high-speed airflow from the first path flows along the guide wall when the airflow deflector sets the first state.

4. The air-blowing device according to claim 3, wherein
the airflow deflector is a butterfly door that has a door body having a plate shape and a rotary shaft provided in a center portion of the door body, and
the door body extends to have a shape protruding in the direction from the first wall toward the second wall and curves to protrude toward a downstream side in the air passage in the flow direction, on a condition that the butterfly door is positioned at a position in the first state.

5. The air-blowing device according to claim 2, wherein
the wall portion and the duct are mounted in a front area in a vehicle,
the wall portion is an upper surface of an instrument panel of the vehicle, and
the direction from the second wall toward the first wall is a direction toward a rear side of the vehicle.

6. The air-blowing device according to claim 5, wherein
the edge extends along a boundary between the instrument panel and a windshield.

7. The air-blowing device according to claim 5, further comprising
a plurality of slit forming portions that are provided in the blowing outlet and form a slit extending in a front-rear direction of the vehicle, wherein
the slit is formed between adjacent two of the plurality of slit forming portions, and
a dimension between the adjacent two of the plurality of slit forming portions on a front side is smaller than a dimension between the adjacent two of the plurality of slit forming portions on a rear side.

8. The air-blowing device according to claim 5, wherein
the target is a passenger having a seat of the vehicle, and
a blowing direction in which air bent along the guide wall blows from the blowing outlet is a direction toward the passenger.
